(19) United States
(12) Patent Application Publication
(10) Pub. No.: US 2026/0296131 A1
(43) Pub. Date: Oct. 1, 2026

(54) VEHICLE

(71) Applicant: HONDA MOTOR CO., LTD., Tokyo (JP)

(72) Inventors: Shinji Kobayashi, Tokyo (JP); Erina Hachisaka, Tokyo (JP); Kenichi Maeda, Tokyo (JP)

(21) Appl. No.: 19/546,964

(22) Filed: Feb. 23, 2026

(30) Foreign Application Priority Data
Mar. 28, 2025 (JP) 2025-056985

(51) Int. Cl. B60H 1/00; B60N 2/01; B60H 3/06

(52) U.S. Cl. CPC B60H 1/00407; B60N 2/01; B60H 3/06

(57) ABSTRACT

In a vehicle including: a vehicle body frame; an air-conditioning unit including a base portion including a heater core, and an intake portion including a filter; and a stay that supports the air-conditioning unit on the vehicle body frame, the base portion and the intake portion are disposed side by side in a vehicle width direction, front surfaces of the base portion and the intake portion are attached to the stay and are substantially flush with each other, a rear surface of the intake portion is positioned on front of a vehicle body relative to a rear surface of the base portion, occupants’ seats include an auxiliary seat between a driver's seat and a passenger’s seat, the base portion faces the auxiliary seat, and the intake portion is positioned on the front of the passenger’s seat.

### INCORPORATION BY REFERENCE

The present application claims priority under 35 U.S.C.§119 to Japanese Patent Application No. 2025-056985 filed on Mar. 28, 2025. The content of the application is incorporated herein by reference in its entirety.

### BACKGROUND

### Technical Field

The present invention relates to a vehicle.

### Related Art

A saddle-ride vehicle in which two or more seats are provided side by side on the left and right, a so-called side-by-side multi utility vehicle (MUV) is conventionally known as a vehicle (see, for example, JP 7434401 B2). JP 7434401 B2 discloses a technique related to attachment of an air-conditioning unit in such an MUV. In JP 7434401 B2, a stay is attached to a front surface of the air-conditioning unit, and the air-conditioning unit is supported by a vehicle body frame via the stay. In JP 7434401 B2, the air-conditioning unit is disposed in a front room, and is covered with a dash panel that defines the front room and a cabin space.

### SUMMARY

The air-conditioning unit is in general a unit component having a size. In a case where the air-conditioning unit is disposed in the vicinity of the cabin space, there is a problem in that the cabin space is easily reduced in size.

The present invention has been made in view of the above circumstances, and it is an object of the present invention to provide a vehicle in which it is possible to provide an air-conditioning unit while keeping the area of a cabin space.

A vehicle includes: a vehicle body frame; an air-conditioning unit including a base portion and an intake portion, the base portion including a heater core, an intake port being provided on the intake portion, the intake portion including a filter; and a stay, which is attached to a front surface of the air-conditioning unit, and which supports the air-conditioning unit on the vehicle body frame, in which the base portion and the intake portion are disposed side by side in a vehicle width direction, a front surface of the base portion and a front surface of the intake portion are attached to the stay, and are substantially flush with each other, a rear surface of the intake portion is positioned on front of a vehicle body relative to a rear surface of the base portion, occupants’ seats include a driver's seat, a passenger’s seat, and an auxiliary seat between the driver's seat and the passenger’s seat, and the base portion is disposed at a position that faces the auxiliary seat, and the intake portion is positioned on the front of the passenger’s seat.

It becomes possible to provide a vehicle in which it is possible to provide an air-conditioning unit while keeping the area of the cabin space.

### BRIEF DESCRIPTION OF DRAWINGS

FIG. 1 is a left side view illustrating an irregular ground travel vehicle according to an embodiment;

FIG. 2 is a longitudinal sectional view of a front portion of the irregular ground travel vehicle according to an embodiment;

FIG. 3 is a right side view illustrating a peripheral portion of an instrument panel frame and an HVAC unit;

FIG. 4 is a perspective view illustrating a peripheral portion of the instrument panel frame and the HVAC unit when viewed from right rear;

FIG. 5 is a front view illustrating the peripheral portion of the instrument panel frame and the HVAC unit;

FIG. 6 is a rear view illustrating the peripheral portion of the instrument panel frame and the HVAC unit;

FIG. 7 is a plan view illustrating a state of a cabin space; and

FIG. 8 is a view illustrating a state in which the instrument panel is removed from FIG. 7.

### DETAILED DESCRIPTION

Hereinafter, embodiments of the present invention will be described with reference to the drawings. Note that, in the description, directions such as front, rear, left, right, up, and down are identical to directions with respect to a vehicle body, unless otherwise specified. In the drawings, reference sign FR denotes the front side of the vehicle body, reference sign UP denotes the upper side of the vehicle body, and reference sign LH denotes the left side of the vehicle body.

### Embodiments

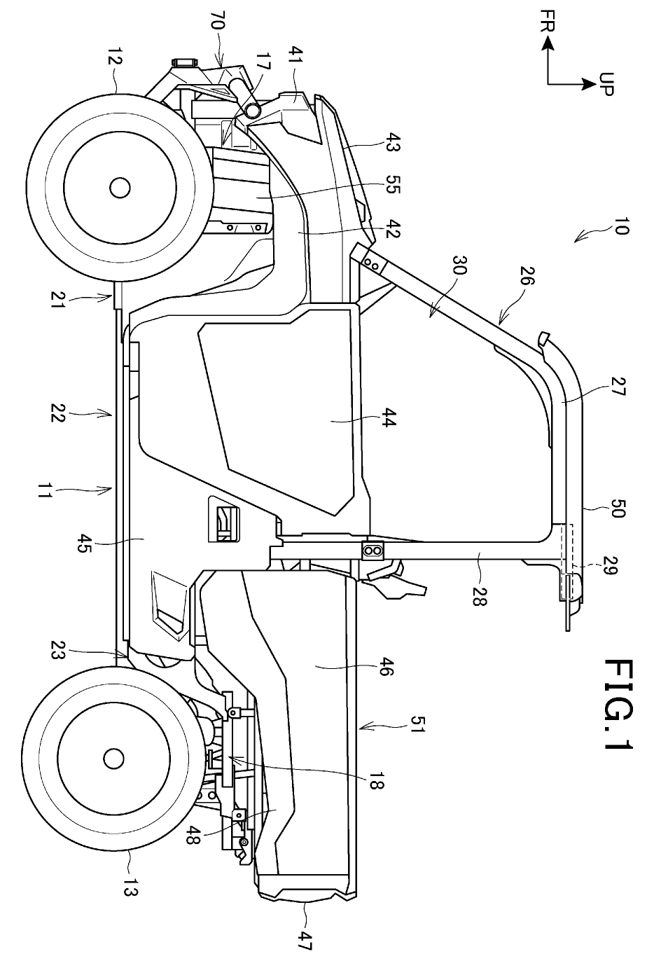

FIG. 1 is a left side view illustrating an irregular ground travel vehicle 10 according to an embodiment.

The irregular ground travel vehicle 10, as an example of the vehicle, is a side-by-side MUV. The irregular ground travel vehicle 10 includes: a vehicle body frame 11; a pair of left and right front wheels 12, which are supported by a front portion of the vehicle body frame 11; a pair of left and right rear wheels 13, which are supported by a rear portion of the vehicle body frame 11; and a power unit (not illustrated) disposed in a lower portion close to the rear of the vehicle body. The irregular ground travel vehicle 10 travels using driving force supplied by the power unit to the front wheels 12 and the rear wheels 13.

The vehicle body frame 11 includes: a front frame 21; a center frame 22, which is connected with a rear portion of the front frame 21; and a rear frame 23, which is connected with a rear portion of the center frame 22. The vehicle body frame 11 also includes the front frame 21, and an upper frame 26, which is attached to extend upward from the center frame 22.

The front wheels 12 are supported by the front frame 21 via a front suspension 17.

The rear wheels 13 are supported by the rear frame 23 via a rear suspension 18.

In a vehicle side view, the upper frame 26 includes: a pair of left and right front pillars 27, which extend rearward and upward from a rear upper portion of the front frame 21 and then extend rearward; a pair of left and right center pillars 28, which respectively extend upward from the center frame 22 and are then connected with rear end portions of the front pillars 27; and a cross frame 29, which connects between rear end portions of the left and right center pillars 28. A roof 50 having a plate shape is attached to the upper side of the upper frame 26.

A space surrounded by the front frame 21, the center frame 22, and the upper frame 26 forms a cabin space 30 which an occupant gets in.

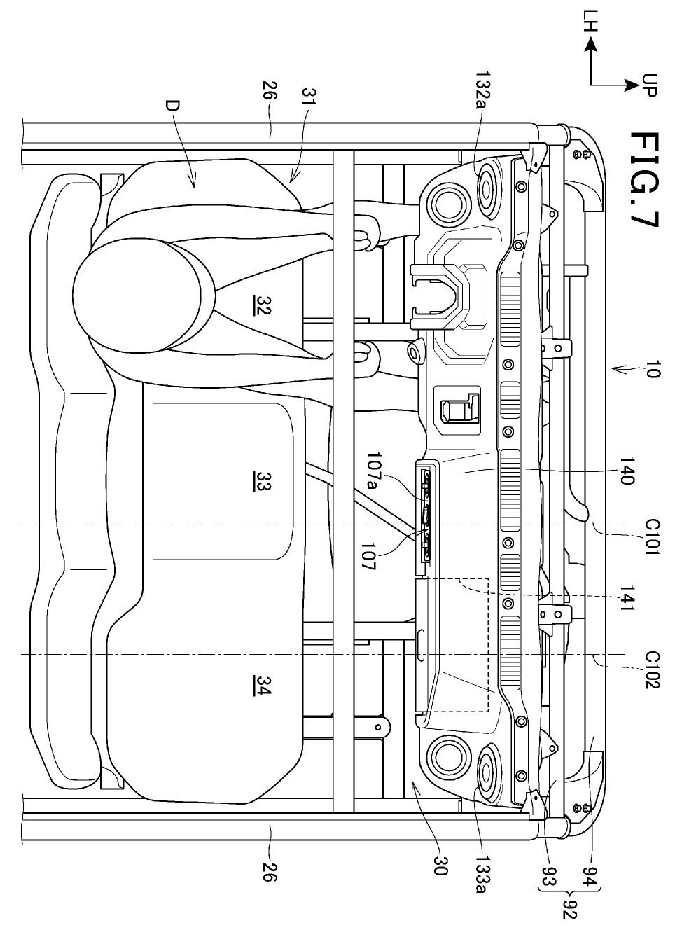

Occupants’ seats 31 (see FIG. 7), on which a driver and a passenger are seated, are disposed inside the cabin space 30. The occupants’ seats 31 include a driver's seat 32, an auxiliary seat 33, and a passenger’s seat 34. Specifically, the driver's seat 32, on which a driver D is seated, is provided on one side in a vehicle width direction. The passenger’s seat 34, on which the passenger is seated, is provided on the other side in the vehicle width direction. The auxiliary seat 33, on which a passenger is seated, is provided between the driver's seat 32 and the passenger’s seat 34. The driver's seat 32, the auxiliary seat 33, and the passenger’s seat 34 are disposed side by side on the left and right. An operation system such as a steering wheel (not illustrated) to be operated by the driver is disposed inside the cabin space 30 to correspond to the front of the driver's seat 32.

The irregular ground travel vehicle 10 includes: a front cover 41, which is provided at a front end portion, and which covers a front end of the irregular ground travel vehicle 10; a front fender 42, which is provided at a rear portion of the front cover 41, and which covers the rear of the front wheel 12 from above the front wheel 12; a front upper cover 43, which is provided above the front fender 42, and which covers a front upper portion of the irregular ground travel vehicle 10; and a front door 44, which is disposed on the rear of the front fender 42, and which is openable and closable via a hinge (not illustrated) at a rear end portion.

The irregular ground travel vehicle 10 also includes: a side cover 45, which is disposed on lower rear of the front door 44, and which covers a lateral portion of the irregular ground travel vehicle 10; a rear side cover 46, which is disposed upper rear of the side cover 45; a rear cover 47, which covers a space between the left and right rear side covers 46 from the rear; and a rear fender 48, which is provided below the rear side covers 46, and which covers the rear wheel 13 from above. The rear side covers 46 and the rear cover 47 cover a cargo bed 51 from the outside. The cargo bed 51 is supported by the rear frame 23. The cargo bed 51 is used as a space for placing a cargo. By disposing a rear seat on the cargo bed 51, another occupant may be seated.

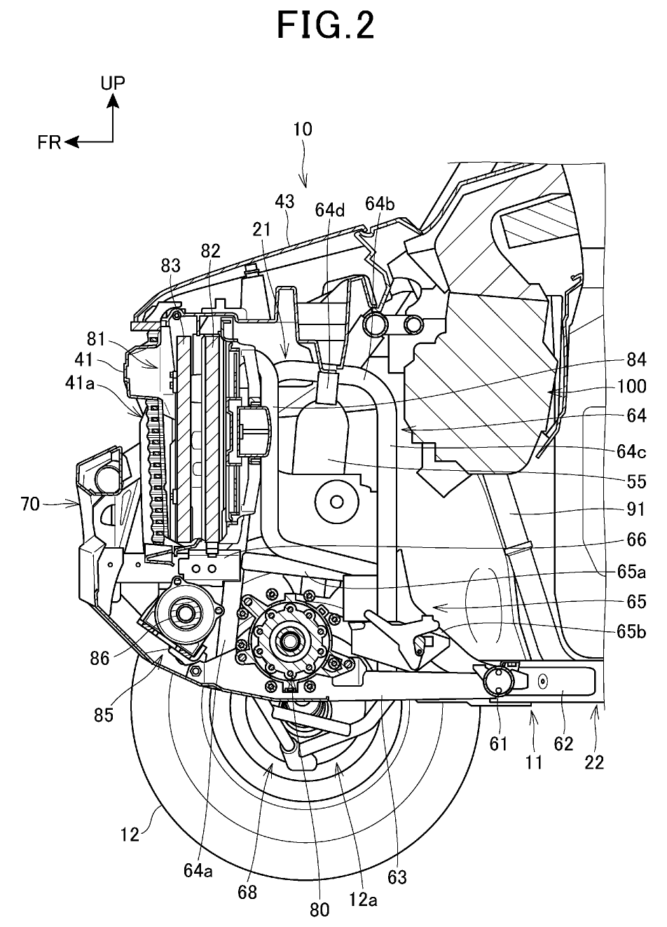

FIG. 2 is a longitudinal sectional view of a front portion of the irregular ground travel vehicle 10 according to an embodiment.

The front frame 21 is connected with a front portion of the center frame 22. The front frame 21 includes a front lower cross frame 61, which has a pipe shape, and which is connected with the center frame 22. The front lower cross frame 61 extends in a vehicle width direction. Gusset portions 62 are provided at both ends in the vehicle width direction of the front lower cross frame 61. The gusset portion 62 is fixed over the front lower cross frame 61 and the center frame 22.

A pair of left and right front lower frames 63, which extend forward, are connected with a central portion in the vehicle width direction of the front lower cross frame 61. An arm bracket (not illustrated) is provided on each front lower frame 63.

A cushion support frame 64, which has a substantially inverted letter U shape in the vehicle side view, is connected with the front lower frame 63. Specifically, the cushion support frame 64 includes: a pair of front and rear vertical frame portions 64a and 64c, which extend upward from the front lower frame 63; and a lateral frame portion 64b, which extends in a front-rear direction, and which connects between upper ends of the vertical frame portions 64a and 64c. The lateral frame portion 64b supports a cushion support portion 64d.

A front upper frame 65, which extends in the front-rear direction, is connected with the cushion support frame 64. A pair of left and right front upper frames 65 are respectively provided to correspond to the left and right cushion support frames 64. The front upper frame 65 includes: a main body portion 65a, which extends in the front-rear direction; and an inclined portion 65b, which extends rearward and downward from a rear end of the main body portion 65a. The main body portion 65a connects between the front and rear vertical frame portions 64a and 64c of the cushion support frame 64. An arm bracket (not illustrated) is provided on the main body portion 65a. The inclined portion 65b is connected at a rear end with the front lower frame 63.

A bumper stay 66, which protrudes forward in accordance with a connection position of the main body portion 65a of the front upper frame 65, is provided on the front vertical frame portion 64a of the cushion support frame 64. The bumper stay 66 is formed in a square pipe shape. The bumper 70 is fixed to the bumper stay 66.

Here, a front wheel lower arm 68 is swingably supported by the arm bracket of the front lower frame 63. A front wheel upper arm (not illustrated) is also swingably supported by the arm bracket of the front upper frame 65. The front wheel lower arm and the front wheel upper arm support the front wheel 12 to be rotatable via a knuckle 12a.

In addition, an upper end of a front cushion unit 55 is coupled with the cushion support portion 64d of the cushion support frame 64. A lower end of the front cushion unit 55 is coupled with the front wheel upper arm.

The front wheel lower arm 68, the front wheel upper arm, the front cushion unit 55, and the knuckle 12a constitute the front suspension 17 according to the present embodiment.

A front wheel final case 80, which includes a differential device and a deceleration mechanism, is disposed between the front lower frame 63 and the front upper frame 65. The front wheel final case 80 is disposed between the front and rear vertical frame portions 64a and 64c of the cushion support frame 64 in a vehicle side view. A front propeller shaft (not illustrated), which extends forward from a power unit (not illustrated), is connected with the front wheel final case 80. A pair of left and right front wheel drive shafts (not illustrated) are connected with the front wheel final case 80. The front wheel drive shafts are respectively connected with the front wheels 12. The front wheel drive shafts transmit the driving force to the front wheels 12.

A radiator unit 81 is disposed on the front, above the front wheel final case 80. The radiator unit 81 is disposed above the bumper stay 66. The radiator unit 81 has a rectangular parallelepiped shape in appearance. The radiator unit 81 includes: a radiator core 82, which has a substantially plate shape, and which has a thickness in the front-rear direction; and a condenser core (a refrigerant cooling unit of the air-conditioner) 83, which has the same shape with the radiator core 82 on the front of the radiator core 82. The radiator core 82 and the condenser core 83 are disposed to overlap each other in the front-rear direction. The radiator unit 81 is covered with the front cover 41. Specifically, a lower half part or more of the radiator unit 81 is covered from the front with a grille portion 41a, which is included in the front cover 41. A refrigerant pipe 84, which is connected with the power unit, is connected with the radiator unit 81.

A winch 85 is disposed below the radiator unit 81. The winch 85 is disposed on the front of the vertical frame portion 64a of the cushion support frame 64. The winch 85 includes a reel 86, which has a cylindrical shape, and around which a wire (not illustrated) is windable.

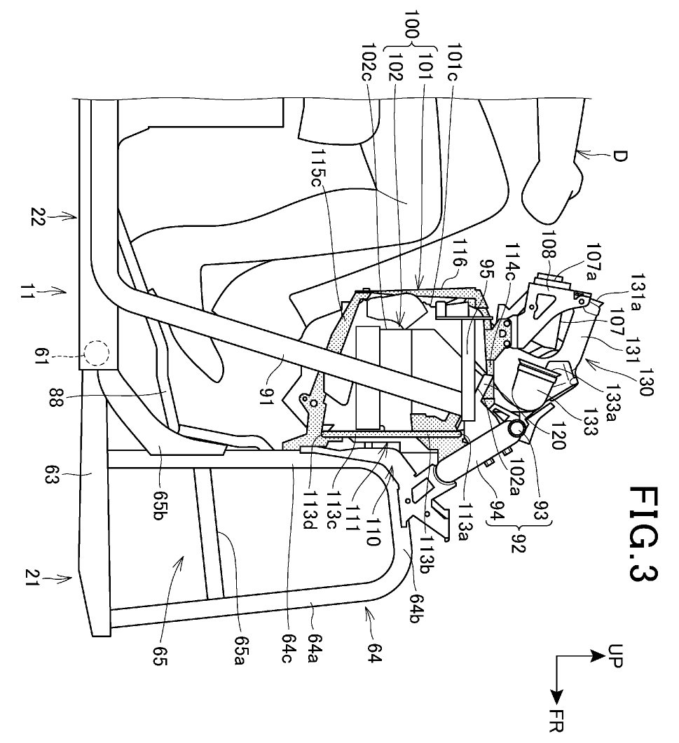

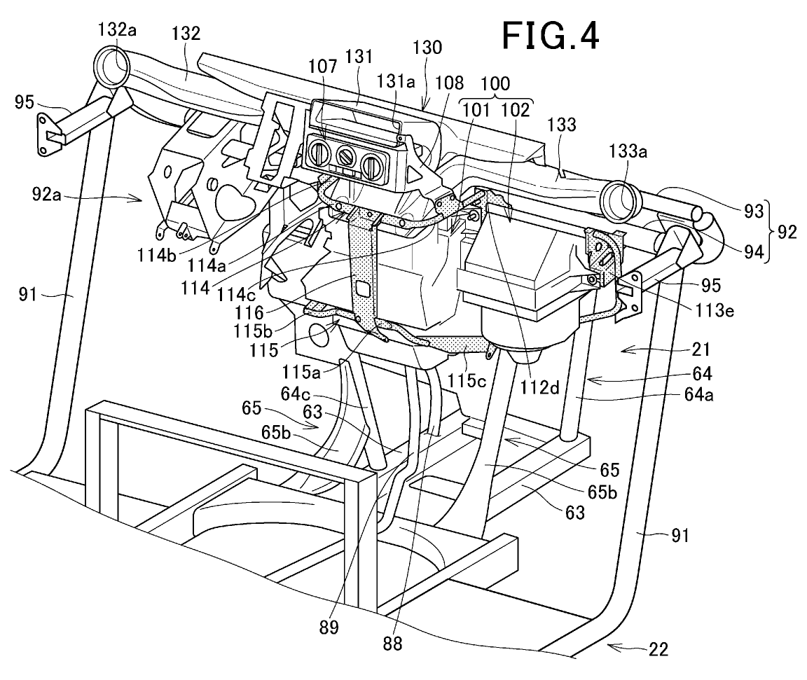

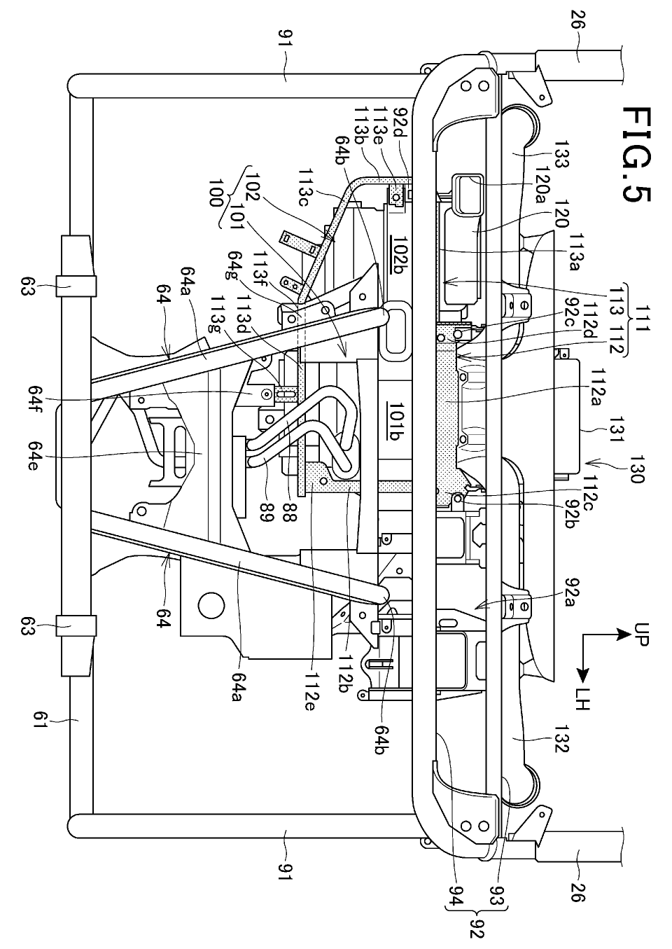

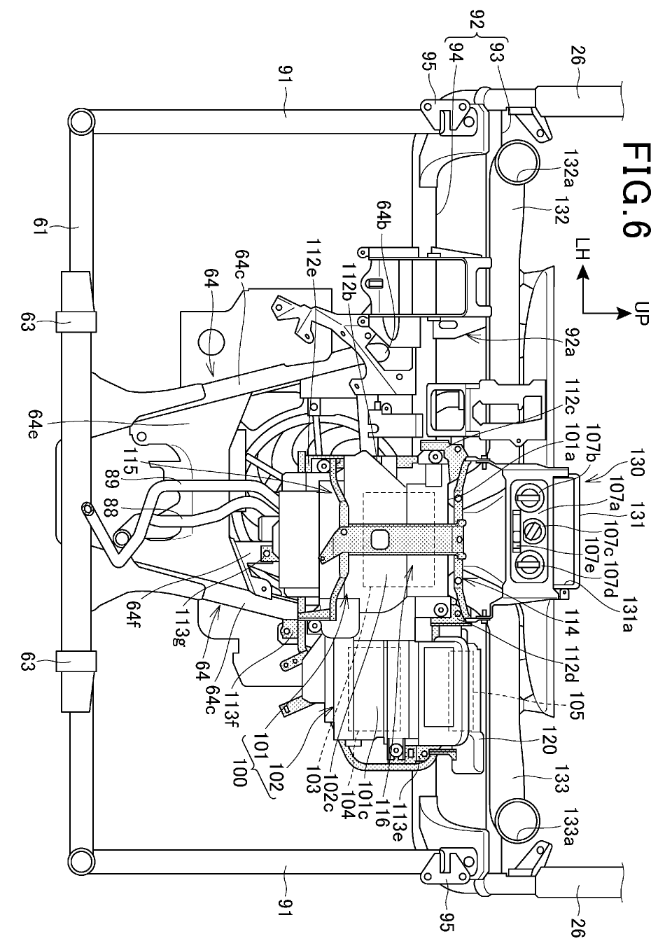

FIG. 3 is a right side view illustrating a peripheral portion of an instrument panel frame 92 and an HVAC unit 100. FIG. 4 is a perspective view illustrating a peripheral portion of the instrument panel frame 92 and the HVAC unit 100 when viewed from the right rear. FIG. 5 is a front view illustrating the peripheral portion of the instrument panel frame 92 and the HVAC unit 100. FIG. 6 is a rear view illustrating the peripheral portion of the instrument panel frame 92 and the HVAC unit 100. Note that in FIGS. 3-6, a unit stay 110 is indicated by a dot pattern.

A pair of left and right support column portions 91, which extend upward, are provided at a front end portion of the center frame 22. The support column portions 91 are slightly inclined forward toward the top. A rearward connection frame 95, which extends rearward, is supported at an upper end of the support column portion 91.

The instrument panel frame 92, which extends in the left-right direction, is supported by upper end portions of the pair of left and right support column portions 91. The instrument panel frame 92 includes: an upper connection frame portion 93, which extends in the left-right direction; and a lower connection frame portion 94, which is connected with both left and right ends of the upper connection frame portion 93, and which extends in the left-right direction. The lower connection frame portion 94 is formed in a flat inverted letter U shape in a vehicle front view.

The instrument panel frame 92 supports operation members to be operated by the driver, various instruments, a heating ventilation, and air-conditioning (HVAC) unit (air-conditioning unit) 100, and the like.

The HVAC unit 100 has a front-rear width, a left-right width, and an up-down width. The left-right width of the HVAC unit 100 is larger than the up-down width and the front-rear width. The HVAC unit 100 includes: a base portion 101; and intake portion 102, which is continuous with the base portion 101 in the left-right direction.

As illustrated in FIG. 6, the base portion 101 includes an evaporator (a heater core and an air cooling unit of an air-conditioner) 103. That is, the evaporator 103 is accommodated in the base portion 101. An exhaust port 101a is formed in an upper portion of the base portion 101.

An intake port 102a (see FIG. 3) is provided in an upper portion of the intake portion 102. The intake portion 102 includes a blower fan 104. A filter 105 is provided downstream of the intake port 102a.

A front surface 101b (see FIG. 5) of the base portion 101 and a front surface 102b (see FIG. 5) of the intake portion 102 are substantially flush with each other. In other words, the front surface 101b and the front surface 102b have less unevenness. At least a rear surface 101c (see FIG. 3) of the base portion 101 has less unevenness than the rear surface 102c (see FIG. 3) of the intake portion 102. The rear surface 101c of the base portion 101 is positioned on the rear of the rear surface 102c of the intake portion 102. In other words, in the HVAC unit 100, the base portion 101 protrudes rearward relative to the intake portion 102.

Air-conditioner refrigerant pipes 88 and 89 are connected with the front surface 101b of the base portion 101, and the HVAC unit 100 is connected with an air-conditioner compressor (not illustrated), the condenser core 83 (see FIG. 2), and an expansion valve (not illustrated) through the air-conditioner refrigerant pipes 88 and 89 and another air-conditioner refrigerant pipe (not illustrated). Here, the air-conditioner compressor is coupled with the power unit, and operates with the rotational power generated by the engine. The refrigerant that has been compressed and raised in temperature by the air-conditioner compressor is cooled by heat exchange with outside air in the condenser core 83, is then rapidly decompressed by an expansion valve, and is supplied to the evaporator 103, which is accommodated in the HVAC unit 100.

In this situation, in the HVAC unit 100, when the blower fan 104 is driven, air is sucked from the intake port 102a. The air passes through the filter 105, and is sent to the evaporator 103. When passing through the evaporator 103, the air exchanges heat with the refrigerant in the evaporator 103, and is cooled. The cooled air is discharged from the exhaust port 101a.

A controller 107, which operates the HVAC unit 100, is disposed above the base portion 101. The controller 107 has a rectangular parallelepiped shape in appearance. Various switches 107b, 107c, 107d, and 107e (see FIG. 6) are provided on an operation surface 107a of the controller 107 on the cabin space 30 side. Specifically, the switch 107b for switching an air blowing area, the switch 107c for switching an air volume, the switch 107d for switching the temperature, and the switch 107e for switching inside or outside air are provided. The controller 107 is disposed above the base portion 101 via a controller stay 108 (see FIG. 3).

The operation surface 107a of the controller 107 protrudes in the cabin space 30 relative to the rear surface 101c of the base portion 101. Accordingly, it is not too far apart from not only the auxiliary seat 33 but also the driver's seat 32 and the passenger’s seat 34, so the operation performance of the controller 107 is easily kept.

An intake duct 120 is connected with the intake port 102a of the HVAC unit 100. An intake port 120a (see FIG. 5), which is opened forward, is formed on the intake duct 120. Air is introduced into the HVAC unit 100 through the intake duct 120.

A blower duct 130 is connected with the exhaust port 101a of the HVAC unit 100. The blower duct 130 includes a central duct 131, a left duct 132, and a right duct 133.

The central duct 131 is connected with the exhaust port 101a of the base portion 101. The central duct 131 extends upward from the base portion 101, turns toward the auxiliary seat 33, and is positioned above the controller 107. A central blowout port 131a, which faces the auxiliary seat 33, is formed at a rear end of the central duct 131. The central blowout port 131a is positioned on the rear relative to the operation surface 107a of the controller 107.

The left duct 132 is connected with the exhaust port 101a of the base portion 101. The left duct 132 extends leftward from the base portion 101, and then bends rearward at a left end portion of the instrument panel frame 92. A left blowout port 132a, which faces the driver's seat 32, is formed at a rear end of the left duct 132. The left blowout port 132a is positioned on the rear relative to the central blowout port 131a (see FIG. 3).

The right duct 133 extends rightward from the exhaust port 101a, and then bends rearward at a right end portion of the instrument panel frame 92. A right blowout port 133a, which faces the passenger’s seat 34, is formed at a rear end of the right duct 133. The right blowout port 133a is positioned on the rear relative to the central blowout port 131a.

Here, the HVAC unit 100 is supported by the instrument panel frame 92 and the front frame 21 via the unit stay 110.

As illustrated in FIG. 5, a plurality of stays 92a, 92b, 92c, 92d, and 92e are provided on the instrument panel frame 92. That is, an operation member support stay 92a is formed on one side in the vehicle width direction of the instrument panel frame 92. A unit support stay 92b is formed on the right side of the central portion in the left-right direction of the instrument panel frame 92. A unit support stay 92c is formed on the right side of the unit support stay 92b. A unit support stay 92d is formed on the right side of the unit support stay 92b. Here, the unit support stays 92b and 92c are not formed on an outer side in the vehicle width direction than the lateral frame portions 64b of the pair of left and right cushion support frames 64 in a front view. On the other hand, the unit support stay 92d is formed on the outer side in the vehicle width direction than the lateral frame portions 64b.

In the front frame 21, the rear vertical frame portion 64c of the left cushion support frame 64 and the rear vertical frame portion 64c of the right cushion support frame 64 are connected with each other by a bridge portion 64e, which extends in the left-right direction. A unit support stay 64f is formed on the bridge portion 64e.

In addition, in the right cushion support frame 64, a unit support stay 64g is formed on the rear vertical frame portion 64c.

As illustrated in FIGS. 3-6, the unit stay (the stay) 110 includes: a front surface stay 111, an upper protection stay 114, which is joined to an upper portion of the front surface stay 111; a lower protection stay 115, which is connected with a lower portion of the front surface stay 111; and a coupling protection frame (a protection portion) 116, which couples the upper protection stay 114 with the lower protection stay 115 in the up-down direction.

As illustrated in FIG. 5, according to the present embodiment, the front surface stay 111 is configured in an annular shape. The front surface stay 111 is formed in an annular shape that surrounds outer peripheral portions of the front surfaces 101b and 102b of the HVAC unit 100. In the front surface stay 111, a plate portion 112, which has a substantially letter L shape in a front view, and a pipe portion 113, which bends in a substantially letter J shape in the front view, are joined together to form a closed annular shape in the front view.

Specifically, the plate portion 112 has a plate shape having a thickness in the front-rear direction. The plate portion 112 includes: an upper left-right extension portion 112a, which extends in the left-right direction; and a lower extension portion 112b, which extends downward from a left end of the left-right extension portion 112a. Fixing portions 112c and 112d are formed at both left and right ends of the left-right extension portion 112a. A unit fixing portion 112e is formed at a lower end of the lower extension portion 112b.

The pipe portion 113 is joined to the plate portion 112. The pipe portion 113 includes: an upper left-right extension portion 113a, which extends rightward from an inner end of the left-right extension portion 112a of the plate portion 112; a lower extension portion 113b, which extends downward from a right end of the left-right extension portion 113a; an inclined portion 113c, which is inclined downward toward the left from a lower end of the lower extension portion 113b; and a lower left-right extension portion 113d, which extends leftward from a lower end of the inclined portion 113c, and is connected with the lower extension portion 112b of the plate portion 112.

In the pipe portion 113, a fixing portion 113e is provided at a connection portion between the upper left-right extension portion 113a and the lower extension portion 112b. In addition, a fixing portion 113f is provided at a connection portion between the inclined portion 113c and the lower left-right extension portion 113d. Further, a frame fixing portion 113g is formed partway in the longitudinal direction of the lower left-right extension portion 113d.

As illustrated in FIG. 4, the upper protection stay 114 has a substantially letter U shape that bulges rearward. The upper protection stay 114 includes: a rear portion 114a, which extends in the left-right direction on the rear of the base portion 101; and side portions 114b and 114c, which extend forward from both left and right ends of the rear portion 114a, and are respectively disposed on the left and right of the base portion 101. Front ends of the side portions 114b and 114c are joined to the left-right extension portion 112a of the plate portion 112 in the front surface stay 111. The controller stay 108 is fixed to the side portions 114b and 114c.

The lower protection stay 115 has a substantially letter U shape that bulges rearward. The lower protection stay 115 includes: a rear portion 115a, which extends in the left-right direction on the rear of the base portion 101; and side portions 115b and 115c, which extend forward from both left and right ends of the rear portion 115a, and are respectively disposed on the left and right of the base portion 101. Front end portions of the side portions 115b and 115c are fixed to a fixing portion of the front surface stay 111.

The rear portion 114a of the upper protection stay 114 and the rear portion 115a of the lower protection stay 115 are coupled with each other by the coupling protection frame 116, which extends in the up-down direction. The coupling protection frame 116 has a plate shape having a thickness in the front-rear direction. The coupling protection frame 116 is disposed on the rear of the base portion 101.

The HVAC unit 100 is fixed to the unit stay 110. The HVAC unit 100 is fixed to the unit stay 110 at upper and lower two positions on outer sides in the left-right direction than the base portion 101. That is, the HVAC unit 100 is fixed to the unit stay 110 at the fixing portion 112c and the unit fixing portion 112e.

The HVAC unit 100 is also fixed to the unit stay 110 at one position on an outer side in the left-right direction than the intake portion 102. That is, the HVAC unit 100 is fixed to the unit stay 110 at the fixing portion 113e.

Furthermore, the HVAC unit 100 is fixed to the unit stay 110 at upper and lower two positions between the base portion 101 and the intake portion 102. That is, the HVAC unit 100 is fixed to the unit stay 110 at the fixing portion 112d and the fixing portion 113f.

The unit stay 110 is fixed to the instrument panel frame 92 and the front frame 21. That is, the fixing portions 112c, 112d, and 113e are respectively fixed to the unit support stays 92b, 92c, and 92d of the instrument panel frame 92. In addition, the fixing portion 113f and the frame fixing portion 113g are respectively fixed to the unit support stays 64g and 64f of the front frame 21.

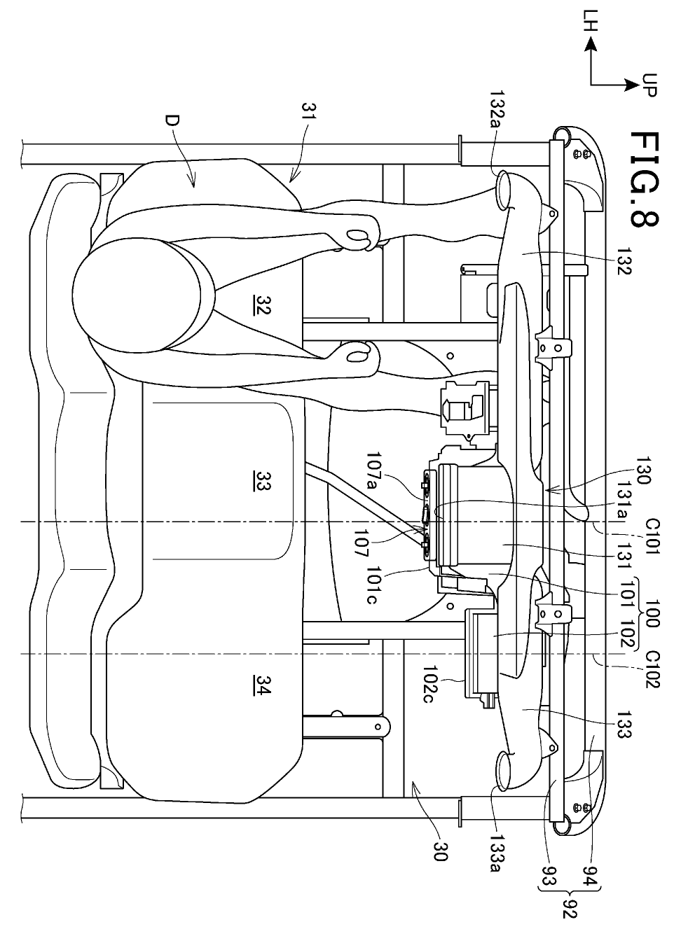

Thus, the HVAC unit 100 is supported by the vehicle body frame 11 via the unit stay 110. In the HVAC unit 100, the base portion 101 faces the auxiliary seat 33, and the intake portion 102 faces the passenger’s seat 34. Specifically, a left-right center line C101 of the base portion 101 passes through the auxiliary seat 33 in a vehicle plan view (see FIG. 8), and a left-right center line C102 of the intake portion 102 passes through the passenger’s seat 34 in the vehicle plan view (see FIG. 8).

FIG. 7 is a plan view illustrating a state of the cabin space 30. FIG. 8 is a view illustrating a state in which an instrument panel 140 is removed from FIG. 7.

The peripheries of the HVAC unit 100 and various instruments are covered with the instrument panel (a cover) 140 from the cabin space 30 side. In this situation, the instrument panel 140 is provided with reference to a rearmost portion of the HVAC unit 100, that is, the rear surface 101c of the base portion 101. Thus, on the front of the instrument panel 140, a space is easily generated on the left and right of the base portion 101, that is, on the front of the driver's seat 32 and on the front of the passenger’s seat 34, as compared with the front of the auxiliary seat 33. Therefore, a steering wheel for operation (not illustrated), various operation components, and meters are disposed on the front of the driver's seat 32. In addition, an article storage portion 141 is provided on the front of the passenger’s seat 34.

In other words, with use of a dead space generated in a case where the steering wheel (not illustrated) necessary for driving operation, various operation components, meters, and the article storage portion 141 are disposed on the front of the instrument panel 140, the base portion 101, which is a protrusion portion of the HVAC unit 100, is disposed. Thus, it becomes possible to dispose the HVAC unit 100 while suppressing the reduction in size of the cabin space 30.

In addition, the coupling protection frame 116 is provided in the HVAC unit 100 according to the present embodiment. Thus, even though, for example, a leg or the like hits the instrument panel 140 and exerts force to deform the instrument panel 140 forward, the upper protection stay 114, the lower protection stay 115, and the coupling protection frame 116 suppress deformation of the instrument panel 140 according to the present embodiment. Therefore, the HVAC unit 100 is also easily protected.

As described heretofore, according to the present embodiment, in the irregular ground travel vehicle 10 including: the vehicle body frame 11; the HVAC unit 100 including the base portion 101, which includes the evaporator 103, and the intake portion 102, on which the intake port 102a is provided, and which includes the filter 105; and the unit stay 110, which is attached to the front surface of the HVAC unit 100, and which supports the HVAC unit 100 on the vehicle body frame 11, the base portion 101 and the intake portion 102 are disposed side by side in the vehicle width direction, the front surface 101b of the base portion 101 and the front surface 102b of the intake portion 102 are attached to the unit stay 110, and are substantially flush with each other, the rear surface 102c of the intake portion 102 is positioned on the front of the vehicle body relative to the rear surface 101c of the base portion 101, the occupants’ seats 31 include the driver's seat 32, the passenger’s seat 34, and the auxiliary seat 33, which is provided between the driver's seat 32 and the passenger’s seat 34, and the base portion 101 is disposed at a position facing the auxiliary seat 33, and the intake portion 102 is positioned on the front of the passenger’s seat 34.

According to this configuration, it becomes possible to provide the irregular ground travel vehicle 10 in which it becomes possible to provide the HVAC unit 100 while keeping the area of the cabin space 30.

In the present embodiment, the unit stay 110 includes the coupling protection frame 116, which covers the rear surface 102c of the base portion 101, and the unit stay 110 is disposed between the instrument panel 140 and the base portion 101.

According to this configuration, even when force in a direction toward the HVAC unit 100 is exerted on the instrument panel 140, the HVAC unit 100 can be easily protected by the coupling protection frame 116.

### Other Embodiments

The above-described embodiments merely describe one aspect of the present invention, and can be optionally modified and applied without departing from the gist of the present invention.

### Configuration Supported by The Above Embodiments

The above embodiments support the following configurations.

Configuration 1 A vehicle including: a vehicle body frame; an air-conditioning unit including a base portion and an intake portion, the base portion including a heater core, an intake port being provided on the intake portion, the intake portion including a filter; and a stay, which is attached to a front surface of the air-conditioning unit, and which supports the air-conditioning unit on the vehicle body frame, in which the base portion and the intake portion are disposed side by side in a vehicle width direction, a front surface of the base portion and a front surface of the intake portion are attached to the stay, and are substantially flush with each other, a rear surface of the intake portion is positioned on front of a vehicle body relative to a rear surface of the base portion, occupants’ seats include a driver's seat, a passenger’s seat, and an auxiliary seat between the driver's seat and the passenger’s seat, and the base portion is disposed at a position that faces the auxiliary seat, and the intake portion is positioned on the front of the passenger’s seat.

According to this configuration, it becomes possible to provide a vehicle in which it becomes possible to provide an air-conditioning unit while keeping the area of the cabin space.

Configuration 2 The vehicle described in the configuration 1, the stay includes a protection portion, which covers a rear surface of the base portion, and the stay is disposed between a cover and the base portion.

According to this configuration, even when force in a direction toward the air-conditioning unit is exerted on the cover, the air-conditioning unit can be easily protected by the protection portion.

### REFERENCE SIGNS LIST

10 Irregular ground travel vehicle (vehicle)

11 Vehicle body frame

31 Occupant’s seats

32 Driver's seat

33 Auxiliary seat

34 Passenger’s seat

100 HVAC unit (air-conditioning unit)

101 Base portion

101b Front surface

101c Rear surface

102 Intake portion

102a Intake port

102b Front surface

102c Rear surface

103 Evaporator (heater core)

105 Filter

110 Unit stay (stay)

116 Coupling protection frame (protection portion)

140 Instrument panel (cover)

What is claimed is:

1. A vehicle comprising: a vehicle body frame; an air-conditioning unit including a base portion and an intake portion, the base portion including a heater core, an intake port being provided on the intake portion, the intake portion including a filter; and a stay, which is attached to a front surface of the air-conditioning unit, and which supports the air-conditioning unit on the vehicle body frame, wherein
the base portion and the intake portion are disposed side by side in a vehicle width direction,
a front surface of the base portion and a front surface of the intake portion are attached to the stay, and are substantially flush with each other,
a rear surface of the intake portion is positioned on front of a vehicle body relative to a rear surface of the base portion,
occupants’ seats include a driver's seat, a passenger’s seat, and an auxiliary seat between the driver's seat and the passenger’s seat, and
the base portion is disposed at a position that faces the auxiliary seat, and the intake portion is positioned on the front of the passenger’s seat.

2. The vehicle according to claim 1, wherein
the stay includes a protection portion, which covers a rear surface of the base portion, and
the stay is disposed between a cover and the base portion.
